(19) United States
(12) Patent Application Publication
(10) Pub. No.: US 2010/0051155 A1
(43) Pub. Date: Mar. 4, 2010

(54) ELASTIC STRAP

(75) Inventor: Marino Macrolei, Camerano (IT)

Correspondence Address: Pearne & Gordon LLP, 1801 East 9th Street, Suite 1200, Cleveland, OH, 44114-3108, US

(73) Assignees: CONEROPLASTIK S.R.L., 60021 Camerano (Ancona) (IT); STAR AUTOFORNITURE S.N.C. DI EVOLI ANDREA & C., 60027 Osimo (IT)

(21) Appl. No.: 12/515,720

(22) PCT Filed: Oct. 3, 2007
(86) PCT No.: PCT/IB2007/002915

§ 371 Date: May 20, 2009

(30) Foreign Application Priority Data
Nov. 22, 2006 (IT) BO2006U000097

(51) Int. Cl. B60C 27/04

(52) U.S. Cl. 152/221

(57) ABSTRACT

An elastic strap (1) to be applied to the wheels of vehicles in the presence of snow and ice to increase wheel adherence to the road surface, comprises a band (2) which extends longitudinally, a central body (3) connected to the longitudinal band (2) and having a main axis of extension (A1), grip means (19) designed to grip the road surface and means (20) for fixing and tightening the band.

### TECHNICAL FIELD

The present invention relates to an elastic strap to be applied to the wheels of motor vehicles in the presence of snow and/or ice.

### BACKGROUND ART

An early embodiment of such a type of strap having claws is described and in the claims in the previous application for an industrial invention patent IT2005MC000051 by the same Applicants.

In particular, the present invention relates to an improved elastic strap which is more effective.

Straps having claws, of the type mentioned above, are fitted in place of normal metal chains by virtue of the many advantages that said substitution brings.

A first of these advantages is significant fitting simplicity, in contrast to the notable difficulties involved in installing metal chains on vehicle wheels.

Fitting metal chains is quite complex in practical terms, time consuming and obliges anyone performing the operation to assume unnatural positions crouched down and stretched out towards the inside of the wheel.

Moreover, in order to operate correctly, a chain often has to be tightened, which may require a certain degree of physical strength that not everyone possesses.

The above-mentioned strap with claws described in the previous patent application substantially provides a solution to the above-mentioned disadvantages, allowing practical, rapid application of the strap on the tyre.

However, the strap may be subject to improvements which guarantee greater effectiveness and more practical use.

In particular, during tests carried out on snow-covered routes, the strap disclosed in the previous patent application did not show, in particular when negotiating curves, satisfactory adherence to the ground.

### DISCLOSURE OF THE INVENTION

The present invention therefore has for an aim to provide an improved elastic strap which is more effective and practical to use and, in particular, which is able to offer greater wheel adherence to the ground in the presence of snow and/or ice.

The technical features of the present invention, in accordance with the above aim, are clear from the content of the claims herein, in particular claim 1 and, preferably, from any of the claims directly or indirectly dependent on claim 1.

### BRIEF DESCRIPTION OF THE DRAWINGS

The advantages of the present invention are more apparent in the detailed description which follows, with reference to the accompanying drawings which illustrate a preferred, non-limiting embodiment of the invention, in which:

FIG. 1 is a schematic top plan view of a preferred embodiment of the elastic strap in accordance with the present invention;

FIG. 2 is a schematic bottom plan view of the strap of FIG. 1;

FIG. 3 is a schematic side elevation view of the strap of the previous figures;

FIG. 4 is an enlarged view of a detail of FIG. 3;

FIG. 5 is an enlarged plan view of a detail of FIG. 1;

FIG. 6 is an enlarged plan view of a detail of FIG. 2;

FIGS. 7 and 8 are respectively a front elevation view and a rear elevation view of the strap of the previous figures;

FIG. 9 is a schematic top plan view of a portion of a second embodiment of the strap in accordance with the present invention;

FIG. 10 is a perspective top view of a detail of the strap of FIG. 9.

### DETAILED DESCRIPTION OF THE PREFERRED EMBODIMENTS OF THE INVENTION

With reference to the accompanying drawings, the numeral 1 denotes as a whole an elastic strap made in accordance with the present invention and designed to be applied to the wheels of motor vehicles in the presence of snow and ice to increase wheel adherence to the road surface.

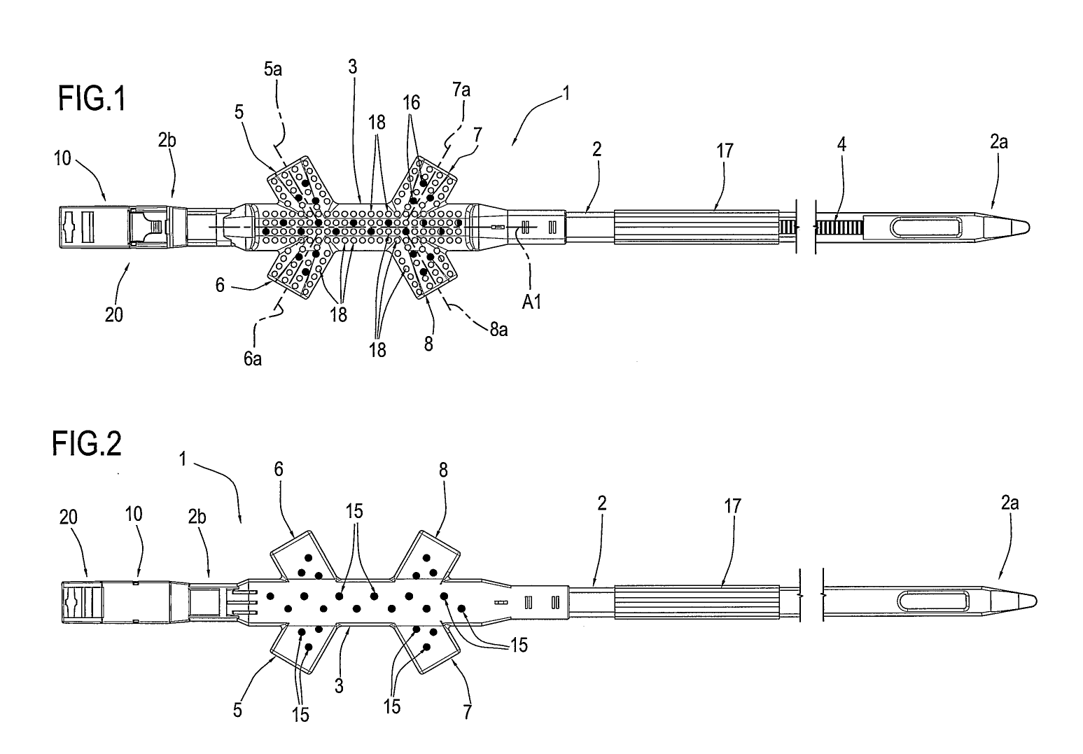

As illustrated in FIG. 1, the elastic strap 1 comprises a band 2 which extends longitudinally and a central body 3, integral with it, the central body 3 having a respective axis of extension A1.

The band 2 comprises a notched segment 4.

Extending from the central body 3, on opposite sides of it relative to the axis A1, there is a plurality of lateral projecting tabs 5, 6, 7, 8.

In particular, the tabs 5, 6, 7, 8 have respective directions of extension 5a, 6a, 7a, 8a set at an angle to the main body 3 axis of extension A1.

The tabs 5, 6, 7, 8 are arranged in pairs, each pair consisting of two tabs 5, 6 and 7, 8 which are symmetrical with one another relative to the axis of extension A1.

Advantageously, the central body 3 and the band 2 are made by overmoulding, a technique which allows a perfect join to be obtained and interpenetration of the two different parts of which the strap consists.

Moreover, advantageously, the band 2 and the central body 3 are made of plastic materials having different mechanical properties and in particular it is important that the material used to make the central body 3 is more deformable when subjected to compression than the material used to make the band 2. For example, the band 2 which extends longitudinally is made of nylon whilst the central body 3 consists of polyurethane or rubber.

The band 2 has two opposite longitudinal ends 2a, 2b, a first of which, end 2a, is pointed.

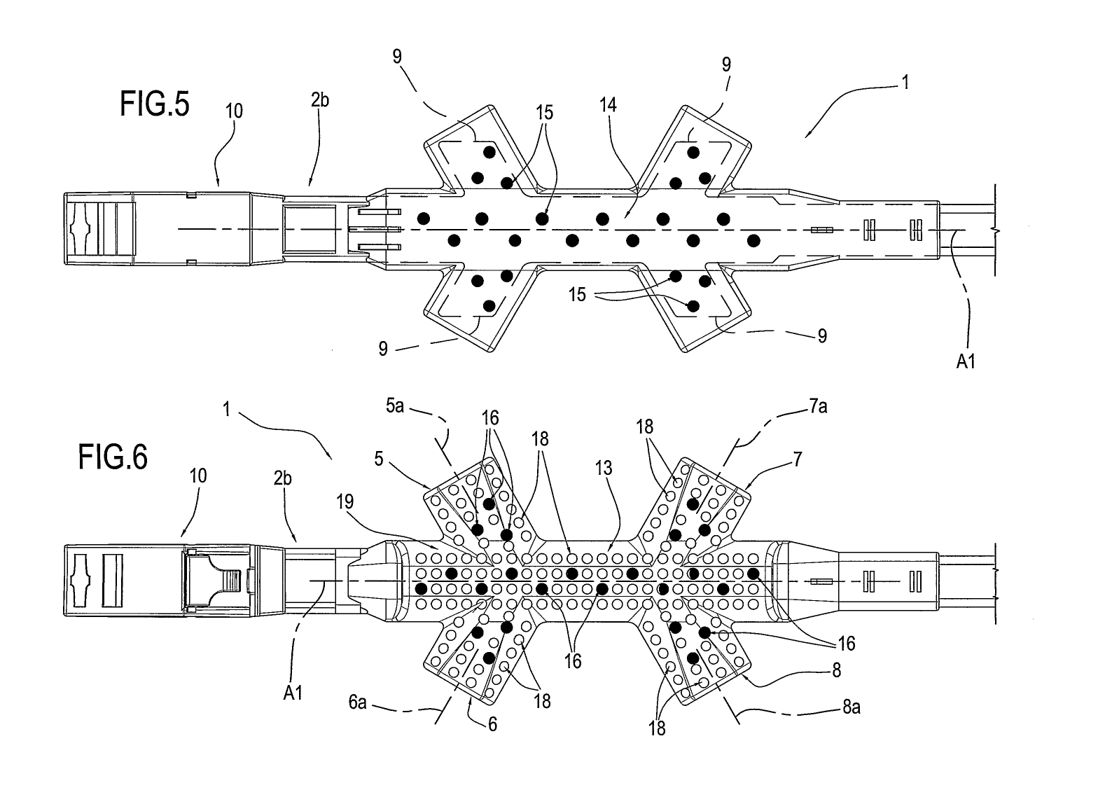

As illustrated in FIG. 5, at the central body 3 of the strap 1, the band 2 has respective protuberances 9, illustrated in transparency with a dashed line, designed to form a kind of inner stiffening framework for the tabs 5, 6, 7, 8.

At the second longitudinal end 2b of the band 2, the strap 1 comprises a block 10 designed in such a way that the band 2 can pass through the inside of it.

Inside the block 10 a lever 11 pivots, the lever having a saw tooth profile 11a, the profile 11a designed to stably engage with the notched segment 4 of the band 2 which extends longitudinally.

With reference to FIG. 4, the lever 11 pivots on the block 10 in such a way that it rotates about an axis A2 perpendicular to the plane of the drawing between a lowered position, illustrated, in which it stably engages with a corresponding portion, not illustrated, of the notched segment 4 of the band 2, thus fixing said segment 4 relative to the block 10, and a raised position, not illustrated, in which it disengages from the notched segment 4 and in which the band 2 can slide inside the block 10 to tighten the strap 1 around the wheel or, vice versa, release the wheel from the strap 1.

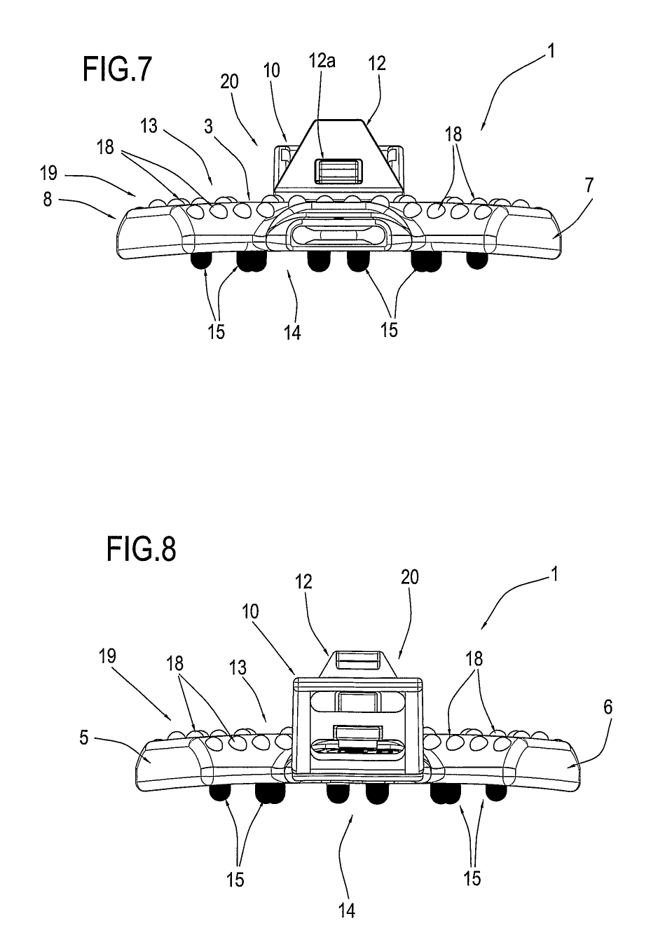

With reference to FIGS. 7 and 8, fixed on the block 10 there is an elastic lug 12 designed to engage, by means of its slot 12a, with the lever 11 to hold the latter in its lowered position for fixing the notched segment 4.

In FIG. 4 the lug 12 is illustrated with a dashed line in a configuration in which it is engaged with the lever 11 whilst it is illustrated with a continuous line in a configuration in which it is disengaged from the lever 11.

As illustrated in FIGS. 1 to 3, the central body 3 has an outer face 13 and an inner face 14 opposite one another and designed to engage, respectively, the road surface and the tread of a tyre, not illustrated.

From the inner face 14 of the central body 3 there emerges a plurality of first pegs 15 to be inserted in the cavities in the tread for expelling water. The first pegs 15, illustrated in a dark colour in the accompanying drawings, are made integral with the band 2 of a material with reduced deformability and emerge from the central body 3 through respective holes in the part of the body 3 made of material with greater deformability.

In practice, the holes are not made by removing material but instead are created during the above-mentioned overmoulding of the strap 1, since around the first pegs 15 integral with the band 2, over a segment of their height, a layer of material with greater deformability such as polyurethane or rubber is deposited.

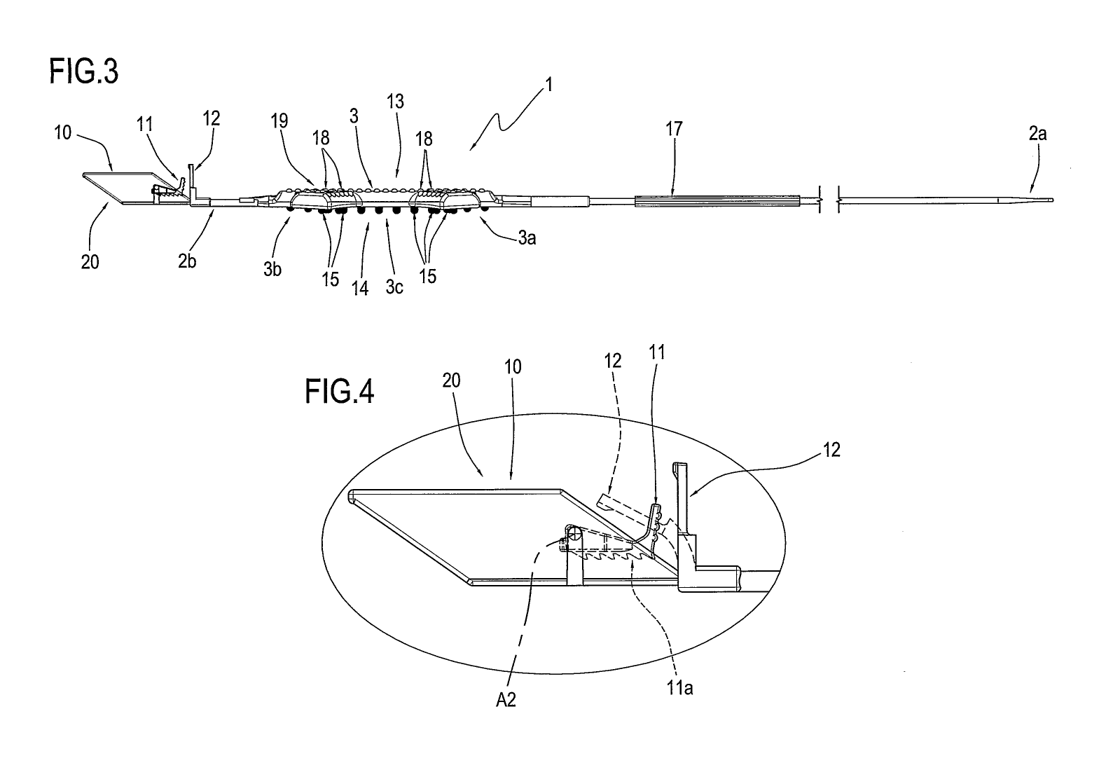

As illustrated in FIG. 3, the height of the first pegs 15 increases starting from the opposite longitudinal ends 3a, 3b of the central body 3 towards a middle zone 3c of the central body 3.

The difference in the heights of the first pegs 15 advantageously in practice guarantees effective contact between the strap 1 and the tyre tread along the entire extension of the central body 3, even after the partial bending to which the strap is subjected when it is fitted by wrapping it around the tyre.

As illustrated in FIGS. 1 and 6, the strap 1 also comprises second pegs 16, also made integral with the band 2 which extends longitudinally, on the opposite side of the band 2 to the first pegs 15.

The second pegs 16 are designed to emerge from the outer face 13 of the central body 3, when there is a deformation of the central body 3 due to compression.

In other words, in normal conditions the second pegs 16 do not emerge from the outer face 13. In practice, they only emerge when the weight of the vehicle against the ground, due to the different compressibility of the two materials, less for that of the band 2 and greater for that of the central body 3, causes a lowering in the thickness of the central body 3 wall and a simultaneous relative raising of the second pegs 16 which can therefore make contact with the road surface, contributing to improving adherence on it.

As illustrated in FIGS. 1 to 3, the strap 1 comprises an annular element 17 slidably fitted on the band 2 which extends longitudinally. The element 17 is made of a material with a high level of elastic deformability and is designed to facilitate strap 1 fitting and/or tightening.

In practice, the annular element 17 is advantageously positioned in contact with any sharp edges of the wheel rim so as to allow easy band 2 sliding inside it during tightening, avoiding possible band 2 jamming on the rim.

Another useful function performed by the annular element 17 is that of protecting the rim from possible scraping by the band 2 which, in practice, could damage the surface of the rim.

The strap 1 also comprises, on the outer face 13 of the central body 3, a plurality of projecting elements 18 having a substantially hemispheric head.

The projecting elements 18 usefully perform the function of avoiding the so-called aquaplaning phenomenon, also common to tyres without chains or the like, and caused by the formation of a substantially even layer of water between the tyre and the road surface.

The presence of the projecting elements 18 therefore helps the water located between the wheel and road surface to run away, by compressing it.

The edges on the central body 3, together with the second pegs 16 and the projecting elements 18 on the outer face 13 of the central body 3 form, for the strap 1, grip means 19 designed to grip the road surface covered with snow or ice.

The blocks 10, lever 11, lug 12 and notched segment 4 of the band 2 form, for the strap 1, respective fixing and tightening means 20.

Advantageously, when the vehicle wheels are positioned in a curved configuration, the tabs 5, 6, 7, 8 are designed to determine respective grip forces on the road surface having main components positioned not only in the direction transversal to the axis of extension A1 of the central body 3 but also in many other directions, so as to considerably increase the adherence of the wheel and therefore of the vehicle on the road surface. Such a circumstance also contributes to maintaining a high level of vehicle stability even in conditions of limited adherence on the road surface.

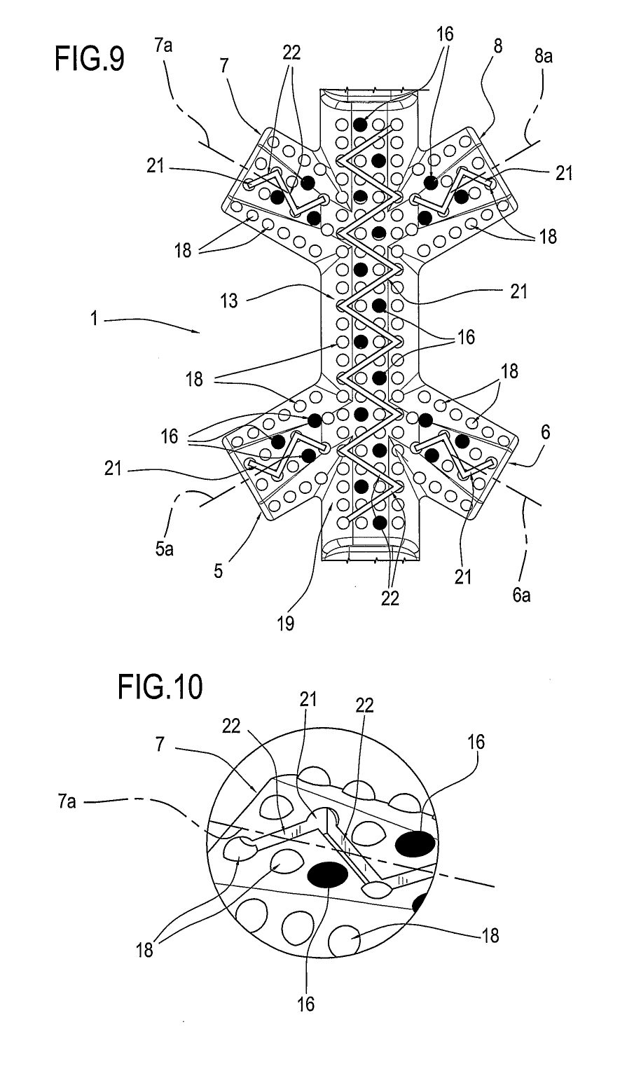

According to the alternative embodiment illustrated in FIGS. 9 and 10, the elastic strap 1 comprises, on the outer face 13 of the central body 3 and on each of the tabs 5, 6, 7, 8, a respective groove 21 designed to further increase strap 1 adherence to the road surface.

Advantageously, the grooves 21 comprise respective straight segments 22 positioned one after another, and each of said segments 22 is set at an angle to each segment 22 adjacent to it.

According to other alternative embodiments of the present invention, not illustrated, the number of lateral projecting tabs is other than four, they are not necessarily arranged symmetrically relative to the axis of extension of the central body 3 and they may be set at different angles to said axis.

For details of the operating steps relating to fitting the strap 1 disclosed on wheels, substantially reference may be made to the content of the description of previous patent application IT2005MC000051 by the same Applicants.

The invention described above is susceptible of industrial application and may be modified and adapted in several ways without thereby departing from the scope of the inventive concept. Moreover, all details of the invention may be substituted by technically equivalent elements.

1. An elastic strap to be applied to vehicle wheels in the presence of snow and ice to increase wheel adherence to the road surface, comprising:
a band (2) which extends longitudinally,
a central body (3) connected to the longitudinal band (2) and having a main axis of extension (A1),
grip means (19) designed to grip the road surface, made on the central body (3),
band fixing and tightening means (20), the elastic strap being characterised in that the central body (3) comprises a plurality of lateral projecting tabs (5, 6, 7, 8).

2. The strap according to claim 1, characterised in that the tabs (5, 6, 7, 8) have respective main directions of extension (5a, 6a, 7a, 8a) substantially set at an angle to the axis (A1) of the central body (3).

3. The strap according to claim 1, characterised in that for each tab (5, 6, 7, 8) of said plurality, it comprises a respective tab (6, 5, 8, 7) positioned symmetrically on the opposite side of the axis of extension (A1) of the central body (3).

4. The strap according to claim 1, characterised in that emerging from an inner face (14) of the central body (3) there is a plurality of first pegs (15) designed to engage against the tyre.

5. The strap according to claim 1, characterised in that the grip means (19) comprise, on an outer face (13) of the central body (3), a plurality of projecting elements (18).

6. The strap according to claim 5, characterised in that the projecting elements (18) have a substantially hemispheric head.

7. The strap according to claim 1, characterised in that the band (2) and the central body (3) are made of plastic materials which have different mechanical properties.

8. The strap according to claim 7, characterised in that the central body (3) is made of a material which is more deformable when subjected to compression than the material used to make the band (2) which extends longitudinally.

9. The strap according to claim 7, characterised in that the band (2) is made of nylon and the central body (3) is made of polyurethane or rubber.

10. The strap according to claim 7, characterised in that emerging from an inner face (14) of the central body (3) there is a plurality of first pegs (15) designed to engage against the tyre, and characterised in that the first pegs (15) are made integral with the band (2) which extends longitudinally and emerge from the inner face (14) through respective holes made in the face (14).

11. The strap according to claim 10, characterised in that the height of the first pegs (15) increases starting from the longitudinal ends (3a, 3b) of the central body (3) towards a middle zone (3c) of the central body (3).

12. The strap according to claim 8, characterised in that it comprises second pegs (16) made integral with the band (2) which extends longitudinally and are designed to emerge from the first outer face (13) of the central body (3) at least when the central body (3) is deformed by compression.

13. The strap according to claim 1, characterised in that it comprises an annular element (17) slidably fitted on the band (2) which extends longitudinally and designed to facilitate strap fitting and/or tightening.

14. The strap according to claim 1, wherein the band (2) which extends longitudinally comprises a notched segment (4) designed to engage with the fixing and tightening means (20) which comprise a block (10) positioned at one end (2b) of the band (2), the strap being characterised in that it comprises a lever (11) having a saw tooth profile (11a) designed to stably engage with the notched segment (4) of the band (2), the lever (11) pivoting on the block (10).

15. The strap according to claim 14, characterised in that the fixing and tightening means (20) comprise an elastically deformable lug (12) designed to engage with the lever (11) to hold the lever in a configuration which fixes the band (2) relative to the block (10).

16. The strap according to claim 1, characterised in that there is at least one groove (21) made on an outer face (13) of the central body (3).

17. The strap according to claim 14, characterised in that a groove (21) comprises a plurality of straight segments (22) positioned one after another, each of said straight segments (22) being set at an angle to each segment (22) adjacent to it.
